(19) United States
(12) Patent Application Publication
(10) Pub. No.: US 2007/0177294 A1
(43) Pub. Date: Aug. 2, 2007

(54) Method for solving heat dissipation problems of computer system and modularized computer system for performing the method

(76) Inventor: Nobuhiro Adachi, Sindian City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/341,686

(22) Filed: Jan. 30, 2006

(51) Int. Cl. G11B 5/02

(52) U.S. Cl. 360/55

(57) ABSTRACT

A modularized computer system includes multiple independent devices including a mini computer host, a power supply, an optical disk drive, a hard disk drive, and a television signal processor connected mutually. Thus, the heat produced by the mini computer host is easily dissipated by the cooling fan, so that the cooling fan needs not to operate at high speed, thereby enhancing the working efficiency of the cooling fan and reducing the noise produced during operation of the cooling fan. In addition, the heat produced by each independent device of the modularized computer system is dissipated by itself so that the heat produced by the modularized computer system is dissipated rapidly, thereby solving the heat dissipation problems.

### BACKGROUND OF THE INVENTION

1. Field of the Invention

The present invention relates to a modularized computer system, and more particularly to a method for solving the heat dissipation problems of a computer system.

2. Description of the Related Art

A conventional computer system comprises a housing for mounting a main board, a power supply, an optical disk drive and a hard disk drive. However, the heat produced by the main board, the power supply, the optical disk drive and the hard disk drive are concentrated in the housing, so that the housing has a higher temperature. Thus, the conventional computer system needs to provide multiple cooling fans which are operated at high speed so as to dissipate the heat, thereby decreased the working efficiency of the cooling fans and increased the noise produced during operation of the cooling fans. In addition, the housing has a larger volume, so that the housing occupies a larger space, thereby causing inconvenience in placement of the housing.

### SUMMARY OF THE INVENTION

The primary objective of the present invention is to provide a method for solving heat dissipation problems of a computer system and a modularized computer system for performing the method.

Another objective of the present invention is to provide a modularized computer system, wherein the heat produced by the mini computer host is easily dissipated by the cooling fan, so that the cooling fan does not need to operate at high speed, thereby enhancing the working efficiency of the cooling fan and reducing the noise produced during operation of the cooling fan.

A further objective of the present invention is to provide a modularized computer system, wherein the heat produced by each independent device of the modularized computer system is dissipated by itself so that the heat produced by the modularized computer system is dissipated rapidly, thereby solving the heat dissipation problems.

A further objective of the present invention is to provide a modularized computer system, wherein each independent device of the modularized computer system has the same length and width, so that the relative positions of the independent devices of the modularized computer system can be changed freely according to the practical requirement.

A further objective of the present invention is to provide a modularized computer system, wherein when the lock is unlocked, information of the hard disk drive will be accessible, and when the lock is locked, information of the hard disk drive will be inaccessible, thereby providing an information security function.

In accordance with one embodiment of the present invention, there is provided a modularized computer system, comprising:

a mini computer host including at least one interface connector group and at least one electric socket each exposed outwardly therefrom, the interface connector group including an optical disk interface connector and a hard disk interface connector;

a power supply connected to the electric socket of the mini computer host to supply an electric power to the mini computer host;

an optical disk drive having an optical interface connecting cord which is connected to the optical disk interface connector of the mini computer host and having a first electric cord which is connected to a first electric source; and

a hard disk drive having a hard disk interface connecting cord which is connected to the hard disk interface connector of the mini computer host and having a second electric cord which is connected to a second electric source.

Furthermore, each of the mini computer host, the optical disk drive and the hard disk drive has the same length and width.

In addition, the first electric source and the second electric source are connected to the power supply by the mini computer host.

Preferably, the hard disk drive has a lock, wherein when the lock is unlocked, information of the hard disk drive will be accessible, and when the lock is locked, information of the hard disk drive will be inaccessible.

In accordance with another embodiment of the present invention, there is provided a method for solving heat dissipation problems of a computer system, comprising:

determining a plurality of temperature intervals according to heat source producing situations of a computer system;

dividing the computer system into a plurality of mutually connected independent devices corresponding to the temperature intervals respectively; and each of the independent devices obtaining an electric source independently.

Moreover, each of the independent devices has the same length and width.

Preferably, the independent devices include a mini computer host, a power supply, an optical disk drive, a hard disk drive, and a television signal processor.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a modularized computer system in accordance with the preferred embodiment of the present invention;

FIG. 2 is a perspective view of a modularized computer system in accordance with another preferred embodiment of the present invention; and

FIG. 3 is a perspective view of a modularized computer system in accordance with another preferred embodiment of the present invention.

### DETAILED DESCRIPTION OF THE INVENTION

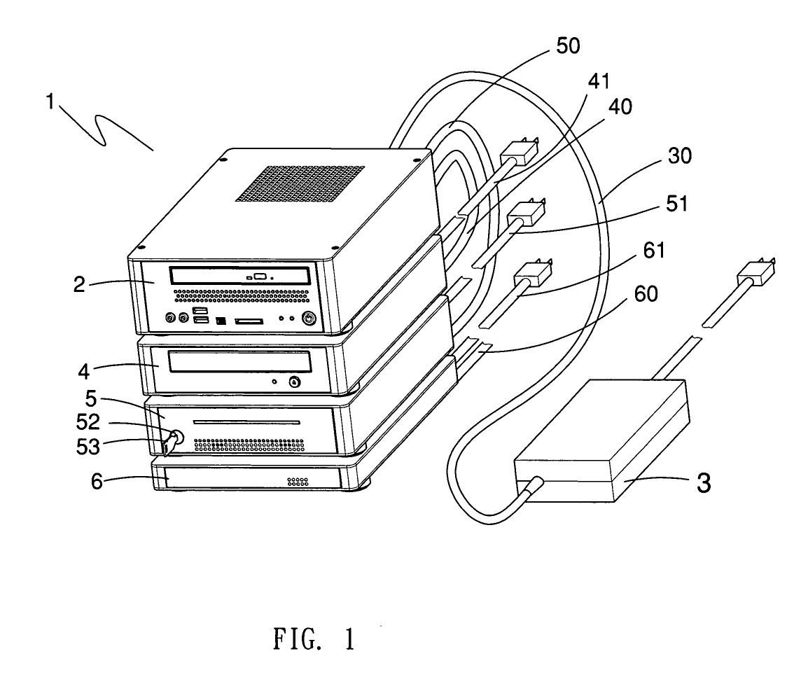

Referring to the drawings and initially to FIG. 1, a modularized computer system 1 in accordance with the preferred embodiment of the present invention comprises a mini computer host 2, a power supply 3, an optical disk drive 4, a hard disk drive 5, and a television signal processor 6. Each of the mini computer host 2, the power supply 3, the optical disk drive 4, the hard disk drive 5 and the television signal processor 6 is an independent device having the same length and width and is connected to an electric power independently. The mini computer host 2, the power supply 3, the optical disk drive 4, the hard disk drive 5 and the television signal processor 6 are connected mutually by connecting lines to form the modularized computer system 1.

The mini computer host 2 includes a main board, a CPU, and a heatsink device. The heatsink device includes a radiator and a cooling fan. The main board has an interface connector group and an electric socket each exposed outwardly therefrom. More specifically, the interface connector group includes an optical disk interface connector and a hard disk interface connector. The optical disk interface connector and the hard disk interface connector are selected from the commonly seen USB connector, the SATA connector, the PATA connector, the SCSI connector and the IDE connector.

Please note that the difference with the conventional computer system is that the interior of the mini computer host 2 doe not contain a power supply, an optical disk drive and a hard disk drive so the heat produced by the power supply, the optical disk drive and the hard disk drive does not exist in the interior of the mini computer host 2. Thus, the mini computer host 2 only has a little heat produced by the active members and passive members of the CPU and the mainboard contained in the mini computer host 2, so that the little heat produced by the mini computer host 2 is dissipated by the heatsink device easily.

However, as shown in FIG. 1, the power supply 3 has a cable 30 (of a direct and alternating current adapter) which is connected to the electric socket of the mini computer host 2 to supply an electric power to the mini computer host 2. In such a manner, the power supply 3 is removed from the mini computer host 2, so that the interior of the mini computer host 2 does not contain the heat and noise produced by the power supply.

Furthermore, as shown in FIG. 1, the optical disk drive 4 has an optical interface connecting cord 40 which is connected to the optical disk interface connector of the mini computer host 2 and has a first electric cord 41 which is connected to a first electric source. In such a manner, the optical disk drive 4 is removed from the mini computer host 2, so that the interior of the mini computer host 2 does not contain the heat and noise produced by the optical disk drive.

As shown in FIG. 1, the hard disk drive 5 has a hard disk interface connecting cord 50 which is connected to the hard disk interface connector of the mini computer host 2 and has a second electric cord 51 which is connected to a second electric source. In such a manner, the hard disk drive 5 is removed from the mini computer host 2, so that the interior of the mini computer host 2 does not contain the heat and noise produced by the hard disk drive.

More specifically, the hard disk drive 5 has a lock 52. The lock 52 may be a key driven lock which is locked or unlocked by a mating key 53. Alternatively, the lock 52 may be a number lock which is unlocked by a code. Thus, when the lock 52 is unlocked, information of the hard disk drive 5 will be accessible, and when the lock 52 is locked, information of the hard disk drive 5 will be inaccessible. In practice, the electric state (such as shutoff or short circuit) of the hard disk drive 5 is changed by the unlocked and locked mechanic actions of the lock 52. Thus, the electric state of the hard disk drive 5 determines if the hard disk drive 5 is accessible.

As shown in FIG. 1, the television signal processor 6 has a television signal connecting cord 60 which is connected to a display (not shown) and has a third electric cord 61 which is connected to a third electric source. In such a manner, the television signal processor 6 is used individually to convert and send the television signal to the display, so that the display can display the television programs. More importantly, the television signal processor 6 is exposed outwardly from the mini computer host 2, so that the interior of the mini computer host 2 does not contain the heat and noise produced by the television signal processor.

It is appreciated that, the first electric source, the second electric source and the third electric source can be obtained from the main electric power (120V or 220V), and can also be obtained from the power supply 3 by connecting the mini computer host 2.

Thus, it is understood that, each of the mini computer host 2, the power supply 3, the optical disk drive 4, the hard disk drive 5 and the television signal processor 6 is an independent device so that they are all or partially interconnected according to the requirement to form a modularized computer system whose functions are similar to that of a traditional computer system, wherein the difference is in that, the heat produced by each independent device of the modularized computer system is dissipated by itself to prevent the heat from being concentrated on the mini computer host 2. Thus, the heat produced by the mini computer host 2 is easily dissipated by the cooling fan, so that the cooling fan does not need to operate at high speed, thereby enhancing the working efficiency of the cooling fan and reducing the noise produced during operation of the cooling fan. In addition, the heat produced by the power supply 3, the optical disk drive 4, the hard disk drive 5 and the television signal processor 6 is much smaller than that produced by the mini computer host 2. Thus, the heat produced by each independent device of the modularized computer system is dissipated by itself so that the heat produced by the modularized computer system is dissipated rapidly, thereby solving the heat dissipation problems.

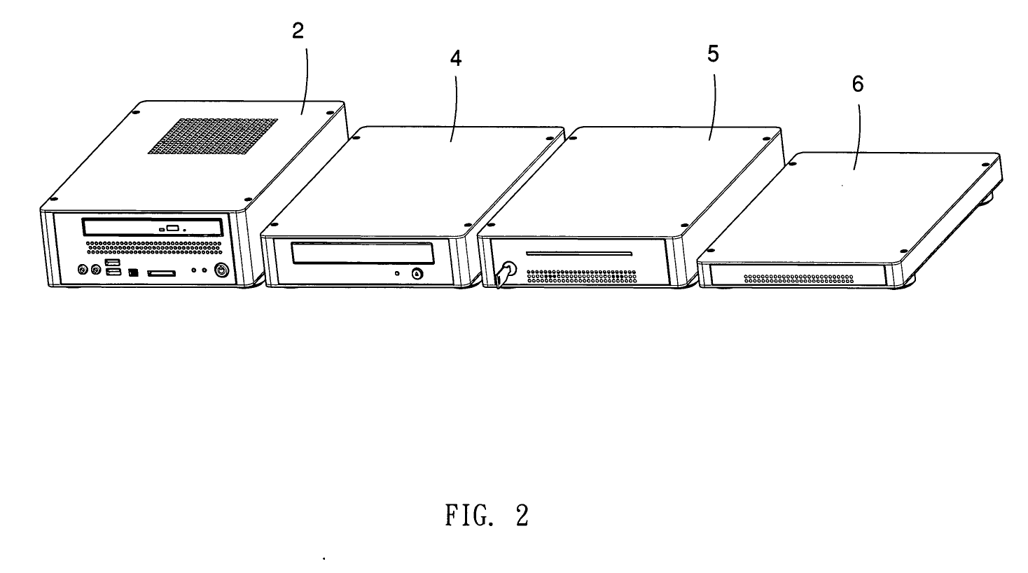

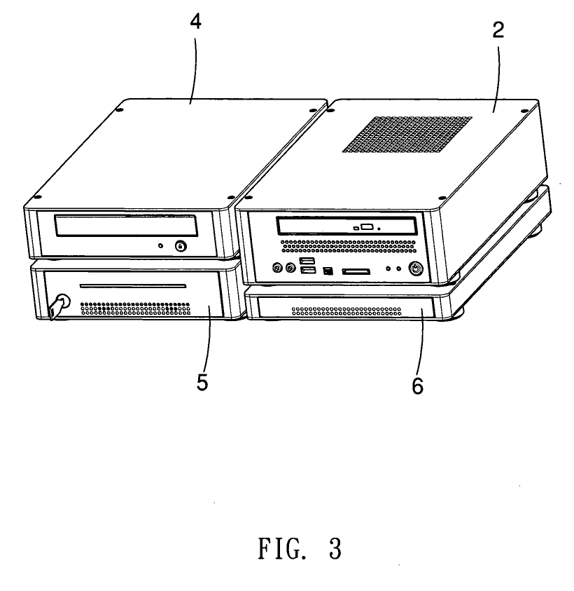

As shown in FIG. 1, the mini computer host 2, the power supply 3, the optical disk drive 4, the hard disk drive 5 and the television signal processor 6 stack in a vertical state. As shown in FIG. 2, the mini computer host 2, the power supply 3, the optical disk drive 4, the hard disk drive 5 and the television signal processor 6 are in line with each other. As shown in FIG. 3, the mini computer host 2, the optical disk drive 4, the hard disk drive 5 and the television signal processor 6 are stack to form two arrays. Thus, the relative positions of the mini computer host 2, the power supply 3, the optical disk drive 4, the hard disk drive 5 and the television signal processor 6 are changed according to the practical requirement and the user's preference.

Accordingly, the heat produced by the mini computer host 2 is easily dissipated by the cooling fan, so that the cooling fan needs not to operate at high speed, thereby enhancing the working efficiency of the cooling fan and reducing the noise produced during operation of the cooling fan. In addition, the heat produced by each independent device of the modularized computer system is dissipated by itself so that the heat produced by the modularized computer system is dissipated rapidly, thereby solving the heat dissipation problems. Further, each independent device of the modularized computer system has the same length and width, so that the relative positions of the independent devices of the modularized computer system can be changed freely according to the practical requirement. Further, when the lock 52 is unlocked, information of the hard disk drive 5 will be accessible, and when the lock 52 is locked, information of the hard disk drive 5 will be inaccessible, thereby providing an information security function.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. A modularized computer system, comprising:
a mini computer host including at least one interface connector group and at least one electric socket each exposed outwardly therefrom, the interface connector group including an optical disk interface connector and a hard disk interface connector;
a power supply connected to the electric socket of the mini computer host to supply an electric power to the mini computer host;
an optical disk drive having an optical interface connecting cord which is connected to the optical disk interface connector of the mini computer host and having a first electric cord which is connected to a first electric source; and
a hard disk drive having a hard disk interface connecting cord which is connected to the hard disk interface connector of the mini computer host and having a second electric cord which is connected to a second electric source.

2. The modularized computer system in accordance with claim 1, wherein each of the mini computer host, the optical disk drive and the hard disk drive has the same length and width.

3. The modularized computer system in accordance with claim 1, wherein the first electric source and the second electric source are connected to the power supply by the mini computer host.

4. The modularized computer system in accordance with claim 1, wherein the hard disk drive has a lock, wherein when the lock is unlocked, information of the hard disk drive will be accessible, and when the lock is locked, information of the hard disk drive will be inaccessible.

5. The modularized computer system in accordance with claim 2, wherein the hard disk drive has a lock, wherein when the lock is unlocked, information of the hard disk drive will be accessible, and when the lock is locked, information of the hard disk drive will be inaccessible.

6. The modularized computer system in accordance with claim 3, wherein the hard disk drive has a lock, wherein when the lock is unlocked, information of the hard disk drive will be accessible, and when the lock is locked, information of the hard disk drive will be inaccessible.

7. The modularized computer system in accordance with claim 1, further comprising a television signal processor having a television signal connecting cord which is connected to a display and having a third electric cord which is connected to a third electric source.

8. The modularized computer system in accordance with claim 7, wherein each of the mini computer host, the optical disk drive, the hard disk drive and the television signal processor has the same length and width.

9. The modularized computer system in accordance with claim 8, wherein the first electric source, the second electric source and the third electric source are connected to the power supply by the mini computer host.

10. The modularized computer system in accordance with claim 7, wherein the hard disk drive has a lock, wherein when the lock is unlocked, the information of the hard disk drive will be accessible, and when the lock is locked, information of the hard disk drive will be inaccessible.

11. The modularized computer system in accordance with claim 8, wherein the hard disk drive has a lock, wherein when the lock is unlocked, information of the hard disk drive will be accessible, and when the lock is locked, information of the hard disk drive will be inaccessible.

12. The modularized computer system in accordance with claim 9, wherein the hard disk drive has a lock, wherein when the lock is unlocked, information of the hard disk drive will be accessible, and when the lock is locked, information of the hard disk drive will be inaccessible.

13. A method for solving heat dissipation problems of a computer system, comprising:
determining a plurality of temperature intervals according to heat source producing situations of a computer system;
dividing the computer system into a plurality of mutually connected independent devices corresponding to the temperature intervals respectively; and
each of the independent devices obtaining an electric source independently.

14. The method in accordance with claim 13, wherein each of the independent devices has the same length and width.

15. The method in accordance with claim 13, wherein the independent devices include a mini computer host, a power supply, an optical disk drive, a and hard disk drive.

16. The method in accordance with claim 14, wherein the independent devices include a mini computer host, a power supply, an optical disk drive, and a hard disk drive.

17. The method in accordance with claim 13, wherein the independent devices include a mini computer host, a power supply, an optical disk drive, a hard disk drive, and a television signal processor.

18. The method in accordance with claim 14, wherein the independent devices include a mini computer host, a power supply, an optical disk drive, a hard disk drive, and a television signal processor.
